(19) United States
(12) Patent Application Publication
(10) Pub. No.: US 2020/0346978 A1
(43) Pub. Date: Nov. 5, 2020

(54) COMPOSITION OF MATTER FOR INHIBITING WATER MIGRATION BETWEEN INSIDE AND OUTSIDE OF CONCRETE

(71) Applicant: Yellow River Engineering Consulting Co., Ltd., Zhengzhou (CN)

(72) Inventors: Jinliang ZHANG, Zhengzhou (CN); Maolin SU, Zhengzhou (CN); Hongqi SHANG, Zhengzhou (CN); Fachen WU, Zhengzhou (CN); Laihong JING, Zhengzhou (CN); Wenran MAO, Zhengzhou (CN); Lin YANG, Zhengzhou (CN); Xueli CHEN, Zhengzhou (CN)

(21) Appl. No.: 16/936,393

(22) Filed: Jul. 22, 2020

Related U.S. Application Data
(63) Continuation-in-part of application No. PCT/CN2018/099072, filed on Aug. 7, 2018.

(30) Foreign Application Priority Data
May 3, 2018 (CN) 201810415559.9

(51) Int. Cl. C04B 24/42; C04B 14/10; C04B 14/04; C04B 40/00

(52) U.S. Cl. CPC C04B 24/42; C04B 14/106; C04B 14/045; C04B 14/041; C04B 40/0046; C04B 14/042

(57) ABSTRACT

A composition of matter, including a phlogopite powder or muscovite powder, clinoptilolite or mordenite, and kaolinite. The composition of matter is prepared as follows: 1) mixing the phlogopite powder or muscovite powder, the clinoptilolite or mordenite, and the kaolinite in a weight ratio of 50-70:0-30:0-50; adding a solution including isopropanol and n-butanol to a mixture of the phlogopite powder or muscovite powder, the clinoptilolite or mordenite, and the kaolinite, thereby yielding a mixed solution; 2) adding a silane coupling agent to the mixed solution, and continuously magnetically stirring the mixed solution for 30 min; adding distilled water to the mixed solution, and continuously magnetically stirring for 30 min; and adding methyl silicone oil to the mixed solution, and magnetically stirring for an hour, thereby yielding a slurry; and 3) drying the slurry at a temperature of 150-200° C.

### CROSS-REFERENCE TO RELATED APPLICATIONS

This application is a continuation-in-part of International Patent Application No. PCT/CN2018/099072 with an international filing date of Aug. 7, 2018, designating the United States, now pending, and further claims foreign priority benefits to Chinese Patent Application No. 201810415559.9 filed May 3, 2018. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND

The disclosure relates to a composition of matter for inhibiting water migration between inside and outside of concrete.

In the construction process, the formation of concrete includes three stages: plasticizing stage, hardening stage and post hardening stage. In the plasticizing stage, water is evaporated from the concrete into the air, and plastic shrinkage cracks tend to occur. In the hardening stage, the water in the capillary pores of the concrete evaporates, leading to drying shrinkage. This shrinkage causes an increase in tensile stress, leading to cracking, internal warping, and external deflection of the concrete when subjected to loading. In the post hardening stage, after years of use, the concrete is water permeable. The water-tightness, or impermeability, of the concrete, is intrinsically related to its durability.

### SUMMARY

The disclosure provides a composition of matter, comprising a phlogopite powder or muscovite powder, clinoptilolite or mordenite, and kaolinite, and the composition of matter being prepared as follows:
1) grinding the phlogopite powder or muscovite powder and sieving using a 300-400 mesh sieve, and drying; grinding the clinoptilolite or mordenite and sieving using a 300-mesh sieve; and calcining the kaolinite at a temperature of 750-800° C., and grinding the kaolinite calcined and sieving using a 500-mesh sieve;
2) mixing the phlogopite powder or muscovite powder, the clinoptilolite or mordenite, and the kaolinite in a weight ratio of 50-70:0-30:0-50; adding a solution comprising isopropanol and n-butanol to a mixture of the phlogopite powder or muscovite powder, the clinoptilolite or mordenite, and the kaolinite, thereby yielding a mixed solution; ultrasonically treating the mixed solution for 10 min, and then magnetically stirring the mixed solution for 10 min at a first rotational speed;
3) adding a silane coupling agent to the mixed solution, and continuously magnetically stirring the mixed solution mixed with the silane coupling agent for 30 min; adding distilled water to the mixed solution mixed with the silane coupling agent, and continuously magnetically stirring for 30 min at a second rotational speed greater than the first rotational speed; and adding methyl silicone oil to the mixed solution mixed with the silane coupling agent and the distilled water, and magnetically stirring for an hour, thereby yielding a slurry; and
4) drying the slurry in a temperature of 150-200° C. into powders, and grinding and sieving the powders, thereby yielding the composition of matter.

The clinoptilolite or mordenite has an ammonium absorption rate greater than or equal to 130 mmol/100 g.

The kaolinite calcined has a specific area greater than or equal to 15000 m²/kg, and comprises greater than or equal to 50 wt. % of SiO₂, and greater than or equal to 40 wt. % of Al₂O₃.

The following advantages are associated with the composition of matter for inhibiting water migration between inside and outside of concrete.

1. The composition of matter comprises phlogopite powder or muscovite powder (mica powder), clinoptilolite or mordenite (zeolite powder), and kaolinite as raw materials. Mica powder is a natural flake mineral with high diameter-thickness ratio. When the mica powder is added to the concrete, a water blocking barrier is formed thus blocking the water migration between inside and outside of the concrete. Zeolite powder is a kind of porous lattice mineral, and can reduce the water bleeding of the concrete. As a kind of ultra-fine admixture, kaolinite can reduce the size and quantity of the micropores of the concrete. The barrier of mica powder, the absorption of zeolite powder and the filling of kaolinite can reduce the speed and volume of the water migration in the plasticizing stage of the concrete.

2. The composition of matter can reduce the surface energy of the capillary pores of the concrete, increase the contact angle between the capillary pores and the water, and reduce the dry shrinkage of the concrete.

3. The surface and interior of the concrete comprising the composition of matter exhibit a superhydrophobic effect, thus reducing the adsorption of the concrete for water, and preventing external water from entering the concrete.

### DETAILED DESCRIPTION

To further illustrate the invention, embodiments detailing a composition of matter for inhibiting water migration between inside and outside of concrete are described below. It should be noted that the following embodiments are intended to describe and not to limit the disclosure.

### Example 1

The disclosure provides a composition of matter for inhibiting water migration between inside and outside of concrete. The composition of matter, with muscovite, mordenite, and kaolinite as raw materials, is prepared as follows:

1) Treatment of raw materials: Muscovite, mordenite having an ammonium absorption rate greater than or equal to 130 mmol/100 g, and kaolinite having a specific area greater than or equal to 15000 m²/kg, and comprising greater than or equal to 50 wt. % of SiO₂ and greater than or equal to 40 wt. % of Al₂O₃ were purchased. The muscovite was ground and sieved using a 400-mesh sieve and dried. The mordenite was ground and sieved using a 300-mesh sieve. The kaolinite was calcined at a temperature of 750-800° C., ground and sieved using a 500-mesh sieve. 60 g of the muscovite powders, 10 g of the mordenite powders and 30 g of the kaolinite powders were evenly mixed in a powder mixer, to yield a base material.

2) Ultrasonic treatment: 50 g of the base material was added to a solution comprising isopropanol and n-butanol (volume ratio of 1:1). The mixture of the base material and the solution was sonicated for 10 min, and then magnetically stirred at 1000 rpm for 10 min.

3) Modified treatment: 3 mL of the silane coupling agent KH-550 was added using a pipette to the mixture obtained in 2). The mixture comprising the silane coupling agent were continuously magnetically stirred for 30 min. 3 mL of distilled water was added to the mixture and stirred at 1100 rpm for 30 min. Thereafter, 6.5 mL of methyl silicone oil was added to the mixture and magnetically stirred for an hour, thereby yielding a slurry.

4) The slurry was dried in a drying box at the temperature of 200° C., and then ground and sieved, thereby yielding the composition of matter.

In actual engineering application, the preparation amount of the composition of matter can be expanded as needed. The composition of matter in this example is particularly suitable for use in the concrete construction for sulfate resistance.

### Example 2

The disclosure provides a composition of matter for inhibiting water migration between inside and outside of concrete. The composition of matter, with muscovite and mordenite as raw materials, is prepared as follows:

1) Treatment of raw materials: Muscovite, and mordenite having an ammonium absorption rate greater than or equal to 130 mmol/100 g were purchased. The muscovite was ground and sieved using a 400-mesh sieve and dried. The mordenite was ground and sieved using a 300-mesh sieve. 70 g of the muscovite powders and 30 g of the mordenite powders were evenly mixed in a powder mixer, to yield a base material.

2) Ultrasonic treatment: 50 g of the base material was added to a solution comprising isopropanol and n-butanol (volume ratio of 1:1). The mixture of the base material and the solution was sonicated for 10 min, and then magnetically stirred at 1000 rpm for 10 min.

3) Modified treatment: 4 mL of the silane coupling agent KH-550 was added using a pipette to the mixture obtained in 2). The mixture comprising the silane coupling agent were continuously magnetically stirred for 30 min. 4 mL of distilled water was added to the mixture and stirred at 1100 rpm for 30 min. Thereafter, 7.5 mL of methyl silicone oil was added to the mixture and magnetically stirred for an hour, thereby yielding a slurry.

4) The slurry was dried in a drying box at the temperature of 150° C., and then ground and sieved, thereby yielding the composition of matter.

In actual engineering application, the preparation amount of the composition of matter can be expanded as needed. The composition of matter in this example is particularly suitable for use in the concrete construction in the dry areas.

### Example 3

The disclosure provides a composition of matter for inhibiting water migration between inside and outside of concrete. The composition of matter, with muscovite and kaolinite as raw materials, is prepared as follows:

1) Treatment of raw materials: Muscovite, and the kaolinite having a specific area greater than or equal to 15000 m²/kg and comprising greater than or equal to 50 wt. % of SiO₂ and greater than or equal to 40 wt. % of Al₂O₃ were purchased. The muscovite was ground and sieved using a 1000-mesh sieve and dried. The kaolinite was calcined at a temperature of 750-800° C., ground and sieved using a 500-mesh sieve. 50 g of the muscovite powders and 50 g of the kaolinite powders were evenly mixed in a powder mixer, to yield a base material.

2) Ultrasonic treatment: 50 g of the base material was added to a solution comprising isopropanol and n-butanol (volume ratio of 1:1). The mixture of the base material and the solution was sonicated for 10 min, and then magnetically stirred at 1000 rpm for 10 min.

3) Modified treatment: 5 mL of the silane coupling agent KH-550 was added using a pipette to the mixture obtained in 2). The mixture comprising the silane coupling agent were continuously magnetically stirred for 30 min. 5 mL of distilled water was added to the mixture and stirred at 1200 rpm for 30 min. Thereafter, 8.5 mL of methyl silicone oil was added to the mixture and magnetically stirred for an hour, thereby yielding a slurry.

4) The slurry was dried in a drying box at the temperature of 200° C., and then ground and sieved, thereby yielding the composition of matter.

In actual engineering application, the preparation amount of the composition of matter can be expanded as needed. The composition of matter in this example is particularly suitable for use in the concrete construction for impermeability and anti-chloride erosion.

### Example 4

Inhibition Test of Water Evaporation

According to the operation steps of the inhibition test of water evaporation specified in Inhibitor of water evaporation in plasticizing stage of concrete (JG/T477-2015, China), the inhibition tests of water evaporation of the compositions of matter in Examples 1-3 were carried out.

The water-cement ratio was 0.40, and the cement satisfied the Chinese National Standard GB8076-2008. The stainless-steel mold was tested, with the size of 300 mm×150 mm×30 mm. The control group was provided with no inhibitor, and the experimental groups were provided with the composition of matter accounting for 3.0 wt. % or 5.0 wt. % of the cement. The test results are shown in Table 1.

TABLE 1
Test results of inhibition of water evaporation

| | | | Inhibition | |
|---|---|---|---|---|
| | | Weight percent of composition | rate (%) | |
| Test group | No. | of matter (wt. %) | 1 h | 4 h |
| Control group | JZ | 0 | / | / |
| Example 1 | YZJ1-3.0 | 3.0 | 55 | 30 |
| | YZJ1-5.0 | 5.0 | 67 | 37 |
| Example 2 | YZJ2-3.0 | 3.0 | 44 | 26 |
| | YZJ2-5.0 | 5.0 | 50 | 33 |
| Example 3 | YZJ3-3.0 | 3.0 | 60 | 28 |
| | YZJ3-5.0 | 5.0 | 73 | 38 |

As shown in Table. 1, in Example 1, when the addition amount of the composition of matter accounts for 3.0% and 5.0% of the cement, one hour later, the inhibition rate of water evaporation of the composition of matter in the concrete are 55% and 67%, respectively; 4 hours later, the inhibition rate of water evaporation of the composition of matter are 30% and 37%, respectively. In Example 2, when the addition amount of the composition of matter accounts for 3.0% and 5.0% of the cement, one hour later, the inhibition rate of water evaporation of the composition of matter are 44% and 50%, respectively; 4 hours later, the inhibition rate of water evaporation of the composition of matter are 26% and 33%, respectively. In Example 3, when the addition amount of the composition of matter accounts for 3.0% and 5.0% of the cement, one hour later, the inhibition rate of water evaporation of the composition of matter are 60% and 73%, respectively; 4 hours later, the inhibition rate of water evaporation of the composition of matter are 28% and 38%, respectively. The results show the inhibition rates of water evaporation of the compositions of matter in the concrete all exceed 25% after 4 hours' experiments, which means the composition of matter of the disclosure satisfies the standard specified in specified in Inhibitor of water evaporation in plasticizing stage of concrete (JG/T477-2015, China).

### Example 5

Tests of Dry Shrinkage and Water Absorption of Concrete

The dry shrinkage tests of concrete in a control group and the test groups were carried out according to the method specified in the standard for test methods of long-term performance and durability of ordinary concrete (GB50082-2009, China).

The water-cement ratio of the concrete was 0.40; the natural medium sand accounted for 40 wt. % of the concrete; the slump was controlled within 180±10 mm; the observation period was 3-28 days, covering the two stages from hardening to post hardening of the concrete. The test results are shown in Table 1.

TABLE 2
Test results of dry shrinkage and water absorption of concrete

| | | Weight | | | | | |
|---|---|---|---|---|---|---|---|
| | | percent | | | | | Water |
| | | of compo- | | | | | absorp- |
| | | sition | | | | | tion |
| Test | | of matter | Dry shrinkage (×10⁻⁶) | | | | (%) |
| group | No. | (wt. %) | 3 d | 7 d | 14 d | 28 d | 28 d |
| Control | JZ | 0 | 120 | 154 | 206 | 273 | / |
| group | | | | | | | |
| Example | YZJ1-3.0 | 3.0 | 50 | 109 | 174 | 253 | 62 |
| 1 | YZJ1-5.0 | 5.0 | 40 | 74 | 139 | 205 | 54 |
| Example | YZJ2-3.0 | 3.0 | 98 | 132 | 180 | 250 | 78 |
| 2 | YZJ2-5.0 | 5.0 | 53 | 86 | 162 | 223 | 60 |
| Example | YZJ3-3.0 | 3.0 | 44 | 110 | 165 | 222 | 60 |
| 3 | YZJ3-5.0 | 5.0 | 32 | 63 | 116 | 168 | 47 |

As shown in Table. 2, compared with the control group, in Example 1, when the addition amount of the composition of matter accounts for 3.0% and 5.0% of the cement, 3 days later, the dry shrinkage of the concrete reduces by 58.3% and 66.7%, respectively; 7 days later, the dry shrinkage of the concrete reduces by 29.2% and 51.9%, respectively; 14 days later, the dry shrinkage of the concrete reduces by 15.5% and 32.5%, respectively; and 28 days later, the dry shrinkage of the concrete reduces by 7.3% and 24.9%, respectively. In Example 2, when the addition amount of the composition of matter accounts for 3.0% and 5.0% of the cement, 3 days later, the dry shrinkage of the concrete reduces by 18.3% and 55.8%, respectively; 7 days later, the dry shrinkage of the concrete reduces by 14.3% and 44.2%, respectively; 14 days later, the dry shrinkage of the concrete reduces by 12.6% and 21.4%, respectively; and 28 days later, the dry shrinkage of the concrete reduces by 8.4% and 18.3%, respectively. In Example 3, when the addition amount of the composition of matter accounts for 3.0% and 5.0% of the cement, 3 days later, the dry shrinkage of the concrete reduces by 66.3% and 73.3%, respectively; 7 days later, the dry shrinkage of the concrete reduces by 28.6% and 59.1%, respectively; 14 days later, the dry shrinkage of the concrete reduces by 19.9% and 43.7%, respectively; and 28 days later, the dry shrinkage of the concrete reduces by 18.7% and 38.5%, respectively. The tests show that the compositions of matter exhibit water retention properties.

The water absorption tests of the hardened concrete in the control group and the test groups were carried out according to the method specified in waterproof agent for mortar and concrete (JC4754-2008, China). The test results are shown in Table 2.

As shown in Table. 2, in Example 1, when the addition amount of the composition of matter accounts for 3.0% and 5.0% of the cement, the water absorption of the concrete is 62% and 54%, respectively. In Example 2, when the addition amount of the composition of matter accounts for 3.0% and 5.0% of the cement, the water absorption of the concrete is 78% and 60%, respectively. In Example 3, when the addition amount of the composition of matter accounts for 3.0% and 5.0% of the cement, the water absorption of the concrete is 60% and 47%, respectively. The tests show that the water absorptions of the concretes mixed with the compositions of matter decreased, which means the compositions of matter can inhibit the permeation of external water into the concrete.

It will be obvious to those skilled in the art that changes and modifications may be made, and therefore, the aim in the appended claims is to cover all such changes and modifications.

What is claimed is:

1. A composition of matter, comprising a phlogopite powder or muscovite powder, clinoptilolite or mordenite, and kaolinite, and the composition of matter being prepared as follows:
1) grinding the phlogopite powder or muscovite powder and sieving using a 300-400 mesh sieve, and drying; grinding the clinoptilolite or mordenite and sieving using a 300-mesh sieve; and calcining the kaolinite at a temperature of 750-800° C., and grinding the kaolinite calcined and sieving using a 500-mesh sieve;
2) mixing the phlogopite powder or muscovite powder, the clinoptilolite or mordenite, and the kaolinite in a weight ratio of 50-70:0-30:0-50; adding a solution comprising isopropanol and n-butanol to a mixture of the phlogopite powder or muscovite powder, the clinoptilolite or mordenite, and the kaolinite, thereby yielding a mixed solution; ultrasonically treating the mixed solution for 10 min, and then magnetically stirring the mixed solution for 10 min at a first rotational speed;
3) adding a silane coupling agent to the mixed solution, and continuously magnetically stirring the mixed solution mixed with the silane coupling agent for 30 min; adding distilled water to the mixed solution mixed with the silane coupling agent, and continuously magnetically stirring for 30 min at a second rotational speed greater than the first rotational speed; and adding methyl silicone oil to the mixed solution mixed with the silane coupling agent and the distilled water, and magnetically stirring for an hour, thereby yielding a slurry; and
4) drying the slurry at a temperature of 150-200° C. into powders, and grinding and sieving the powders, thereby yielding the composition of matter.

2. The composition of matter of claim 1, wherein the clinoptilolite or mordenite has an ammonium absorption rate greater than or equal to 130 mmol/100 g.

3. The composition of matter of claim 1, wherein the kaolinite calcined has a specific area greater than or equal to 15000 m²/kg, and comprises greater than or equal to 50 wt. % of SiO₂, and greater than or equal to 40 wt. % of Al₂O₃.
